(19) United States
(12) Patent Application Publication
(10) Pub. No.: US 2014/0041949 A1
(43) Pub. Date: Feb. 13, 2014

(54) Indirect Material Weighing Sensor

(71) Applicant: Melvin D KERNUTT, Miles City, MT (US)

(72) Inventor: Melvin D KERNUTT, Miles City, MT (US)

(21) Appl. No.: 13/962,398

(22) Filed: Aug. 8, 2013

Related U.S. Application Data
(60) Provisional application No. 61/681,266, filed on Aug. 9, 2012.

(51) Int. Cl. G01G 19/00

(52) U.S. Cl. CPC G01G 19/00
USPC 177/1; 177/50

(57) ABSTRACT

A fiberglass strand measuring device is provided for the open mold process. The device is configured to mount on the exterior of the chopper air motor, which is customarily occupied by the motor end cap. This invention provides a method to measure strand fiberglass without directly contacting the raw material. The indirect measurement is accomplished by attaching a standoff with a magnet to an armature of a motor. Rotation of the armature results in rotation of the standoff and thus circular motion of the magnet. Each rotation can thus be detected by a hall effect sensor as the magnet passes the hall effect sensor. The weight of the strand fiberglass can then be calculated using a provided linear density. A handle can be included to provide additional stability and support for an operator of the chopper gun. The device becomes an integral part of the chopper gun requiring no maintenance.

The current application claims a priority to the U.S. Provisional Patent application Ser. No. 61/681,266 filed on Aug. 9, 2012.

### FIELD OF THE INVENTION

The present invention relates generally to a method and apparatus for monitoring raw material. More specifically, the present invention relates to the weight measurement of strand fiberglass as to raw material monitoring, using a conversion from linear feet to pounds.

### BACKGROUND OF THE INVENTION

Fiberglass is a versatile material with a wide range of applications. Fiberglass offers numerous beneficial properties which can be provided for an item by means of a fiberglass coating. A common method of applying fiberglass involves a dispensing device, such as a chopper gun, and a supply of raw material, e.g. strand fiberglass. By feeding the strand fiberglass through a chopper gun or similar apparatus, a coating can be provided for an item.

Proper application procedures entail determining a specific amount of fiberglass required for a surface. Generally the amount of fiberglass needed is expressed as a weight. Different applications and surfaces will require varying weights of fiberglass to achieve a sufficient coating. Thus, weight measurement capability must be provided in addition to the fiberglass dispensing means. While there are several methods and devices for the weighing of strand fiberglass, a pressure based scale or stand-alone sensor are the most common choice. Though these options perform their intended function, they have several drawbacks. For example, both scales and stand-alone sensors require constant maintenance. Scales must continually be calibrated and are susceptible to damage. Stand-alone sensors must be constantly cleaned to prevent drag or snags as the strand fiberglass passes through the sensor, which can result in inaccuracies in the measuring process. There exists a need for a low maintenance and indirect measurement system for strand fiberglass.

It is therefore an object of the present invention to provide a strand measuring system which can be mounted to a chopper motor. It is a further object of the present invention to provide non-contact measurement capabilities by means of a standoff connected magnet and a hall effect sensor.

### BRIEF DESCRIPTION OF THE DRAWINGS

FIG. 1 is a perspective view of the sensor housing.

FIG. 2 is another perspective view of the sensor housing showing the adapter hole.

FIG. 3 is a common side view of the hall effect sensor with wires.

FIG. 4 is a perspective view of the standoff and sensor activating magnet.

FIG. 5 is a perspective view of the sensor adapter.

FIG. 6 is a perspective view of the optional handle that connects to an end cap, with the end cap omitted for ease of disclosure.

FIG. 7 is an exploded view of the present invention.

FIG. 8 is a perspective view of the assembled present invention.

FIG. 9 is a side view of the present invention installed onto a rendition of a chopper air motor.

FIG. 10A shows a first perspective view of an adapter mounting plate.

FIG. 10B shows a second perspective views of an adapter mounting plate.

FIG. 11 shows an exploded view of the present invention with the adapter mounting plate.

FIG. 12 is an illustration showing the standoff being attached to an armature.

FIG. 13 is an illustration of the hollow sensor housing being attached to a chopper air motor and enclosing a standoff.

FIG. 14 is an illustration of the complete present invention attached to a chopper air motor.

FIG. 15 is an illustration of the present invention in assembled form un-attached to a commonly used chopper air motor.

FIG. 16 is an illustration of the present invention in assembled form attached to a commonly used chopper air motor.

FIG. 17 is an outline of the relation between components during operation of the present invention.

### DETAIL DESCRIPTIONS OF THE INVENTION

All illustrations of the drawings are for the purpose of describing selected versions of the present invention and are not intended to limit the scope of the present invention.

The present invention is an apparatus which is used to indirectly measure the weight of strand fiberglass being fed through a fiberglass applying device. The present invention comprises a hollow sensor housing 1, an end cap 2, a sensor adapter 3, a hall effect sensor 4, a sensor wire 5, a standoff 6, and a handle 7. The hollow sensor housing 1 is attached to the motor 8, where it is mounted to a section that normally is closed by a motor end cap. The standoff 6 is attached to the armature 9 of the motor 8, with a portion of the standoff 6 being positioned within the hollow sensor housing 1. The sensor adapter 3, which houses the hall effect sensor 4, is oriented perpendicular to the hollow sensor housing 1. The sensor wire 5 is electrically connected to the hall effect sensor 4 and allows data from the hall effect sensor 4 to be transmitted to an external monitoring system 45.

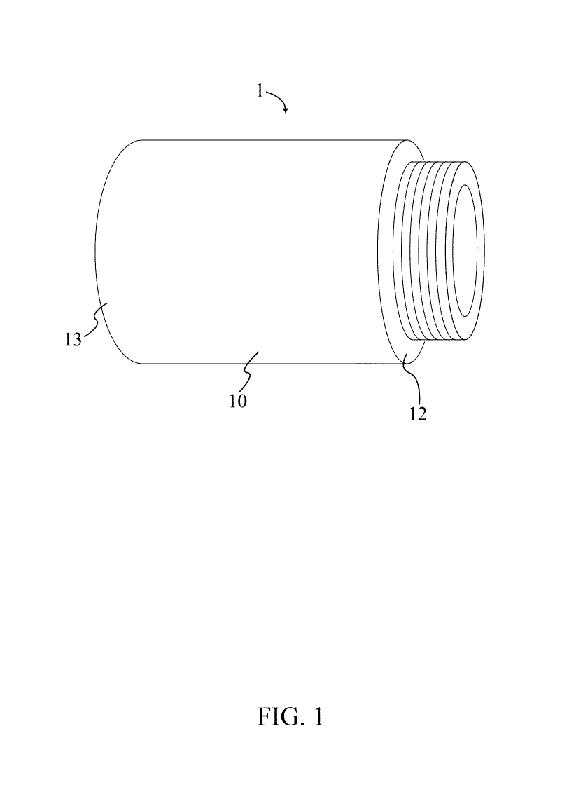

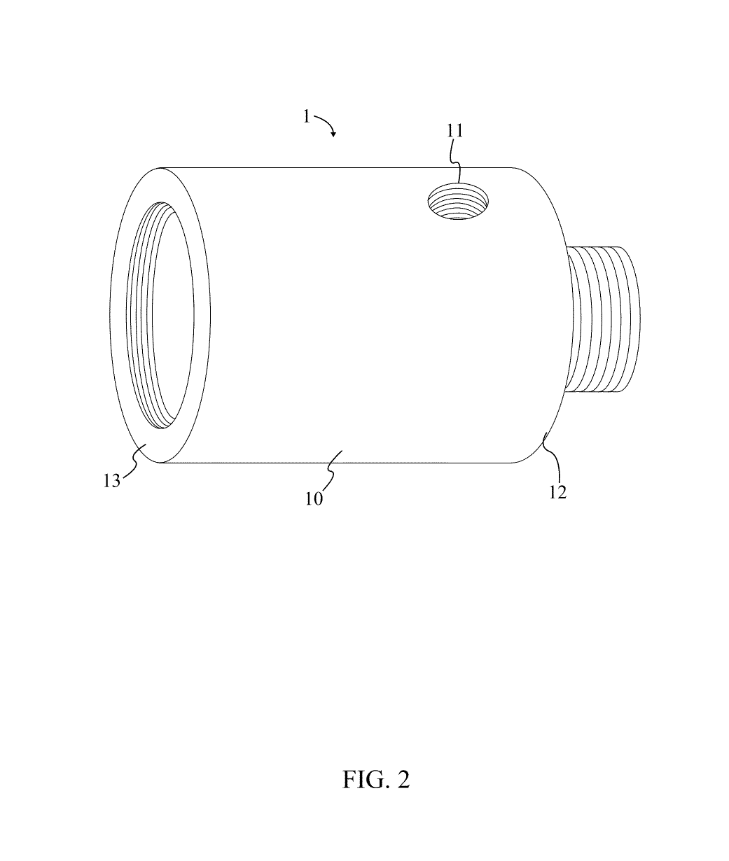

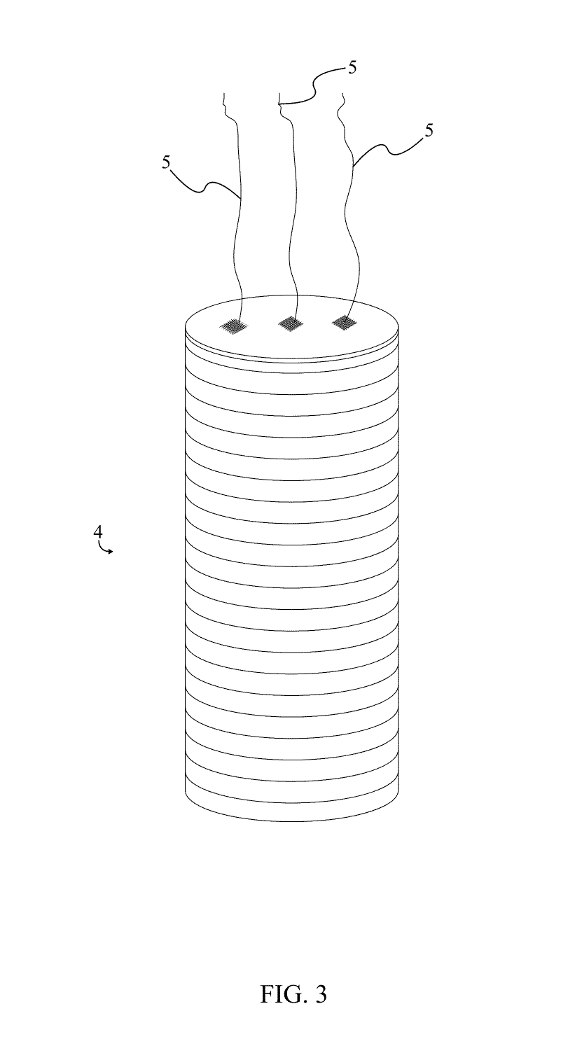

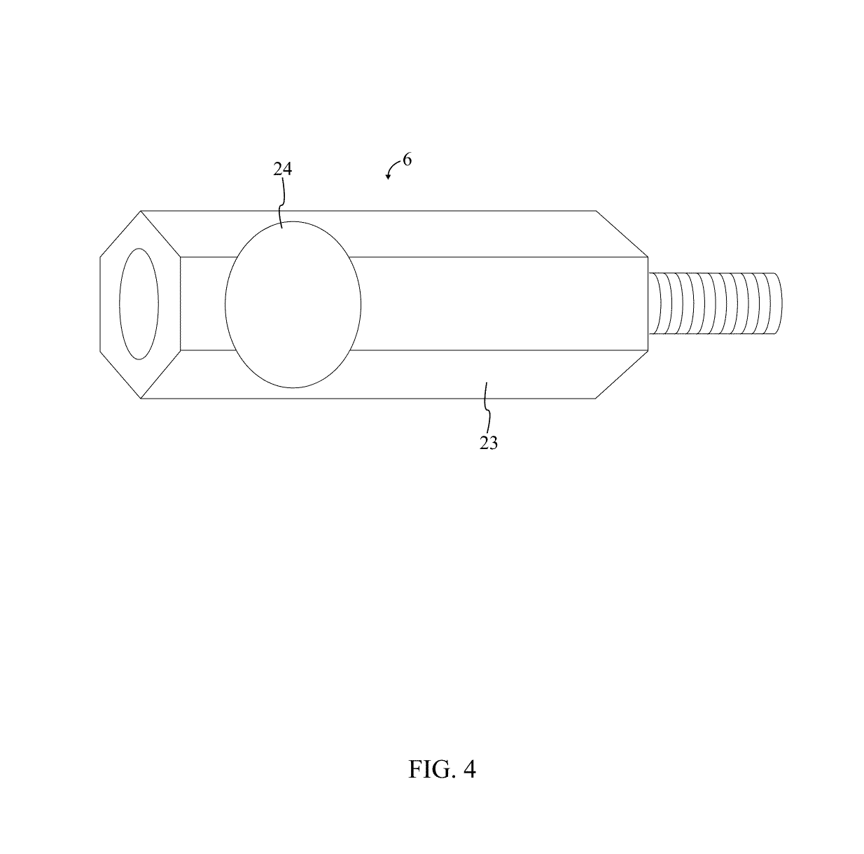

The sensor housing, illustrated in FIG. 1 and FIG. 2, comprises an annular wall 10, an adapter hole 11, a motor end 12, and a free end 13. The adapter hole 11 is positioned on the annular wall 10, and is oriented such that the adapter hole 11 laterally traverses through the annular wall 10. The motor end 12 and free end 13 are positioned opposite each other along the annular wall 10, serving as attachment points for the motor 8 and the end cap 2, respectively. The motor end 12 attaches to the motor 8 adjacent to the armature 9, in place of the standard end cap 2. The adapter hole 11 traverses laterally through the annular wall 10, and serves as a mounting point for the sensor adapter 3. Additionally, the adapter hole 11 receives part of the hall effect sensor 4 (FIG. 3), which is inserted through the adapter hole 11 into the hollow sensor housing 1. The interior of the hollow sensor housing 1 receives the standoff 6 (FIG. 4) through the motor end 12.

In the preferred embodiment the hollow sensor housing 1 is an aluminum tubular shaped component, open at each end. In alternate embodiments the hollow sensor housing 1 could be made of a different shape. For example, rather than having a cylindrical shape, the hollow sensor housing 1 could be shaped like a cube. Potentially, the hollow sensor housing 1 could be any shape with two parallel sides connected by walls, i.e. a prism. Regardless of embodiment, the function of the hollow sensor housing 1 is to provide an enclosed area for the standoff 6 and a mounting point for the hall effect sensor 4.

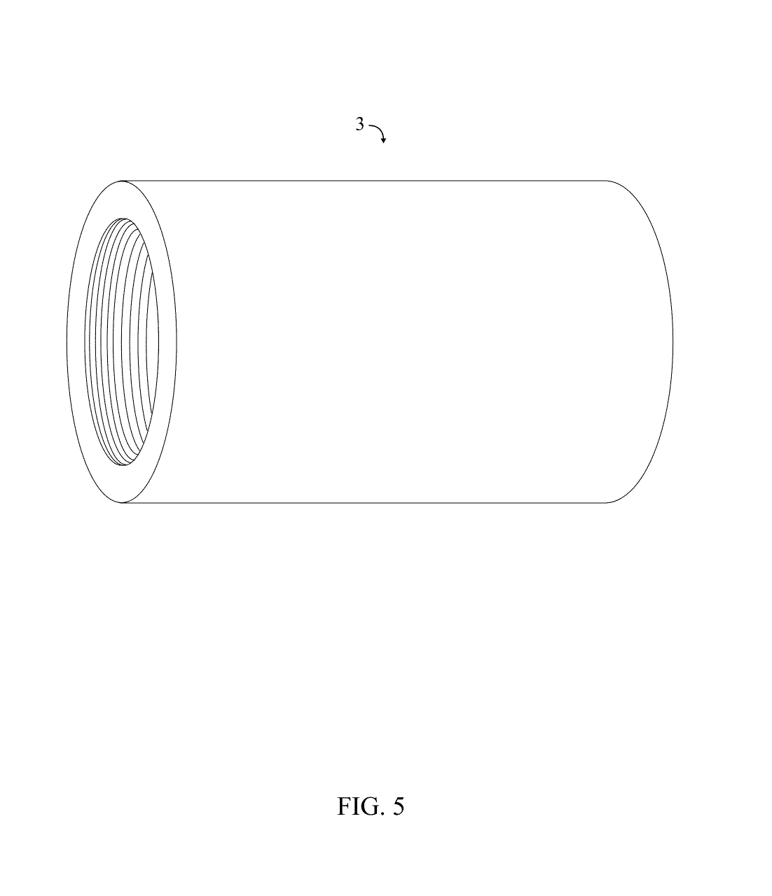

The sensor adapter 3, shown in FIG. 5, is attached to the hollow sensor housing 1 at the adapter hole 11. The sensor housing contains the hall effect sensor 4 itself and allows the hall effect sensor 4 to be secured in the proper position. The hall effect sensor 4 traverses from the sensor adapter 3 through the adapter hole 11 and into the hollow sensor housing 1, terminating interior to the hollow sensor housing 1. Similar to the hollow sensor housing 1, the sensor adapter 3 is preferably made from aluminum.

The sensor wire 5 is electrically connected to the hall effect sensor 4 ,as shown in FIG. 3, and allows data to be transmitted from the hall effect sensor 4 to the monitoring system 45. Covering the sensor wire 5 is a protective tubing 14. The protective tubing 14 is attached to the sensor adapter 3 by a compression fitting 15, providing a liquid resistant seal. The combination of the sensor adapter 3, compression fitting 15, and protective tubing 14 provides a sealed barrier that prevents debris from entering the sensor adapter 3 and potentially interfering with the hall effect sensor 4. The sensor wire 5 itself is similarly protected, as it is routed from the sensor adapter 3 (where it is connected to the hall effect sensor 4) through the compression fitting 15 and into the protective tubing 14.

In the preferred embodiment the sensor wire 5 comprises an active wire, a ground wire, and a data wire. The active wire carries five volts of direct current electricity from a display monitor of the monitoring system 45 to the hall effect sensor 4. The data wire enables communication between the hall effect sensor 4 and the monitoring system 45. The compression fitting 15 is preferably of a stainless steel construction. The protective tubing 14 is preferably made from a polyethylene material.

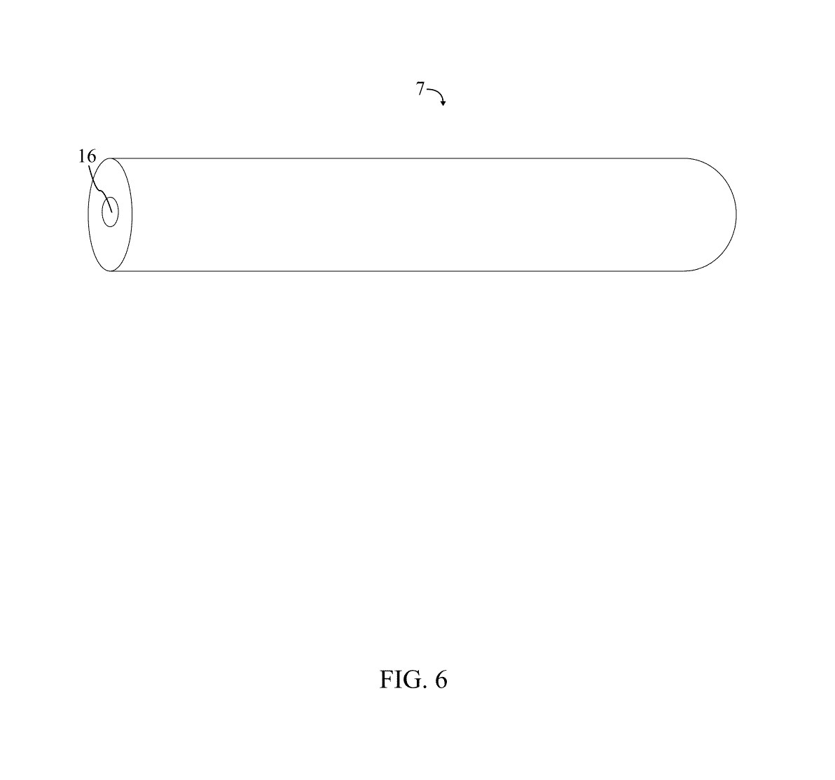

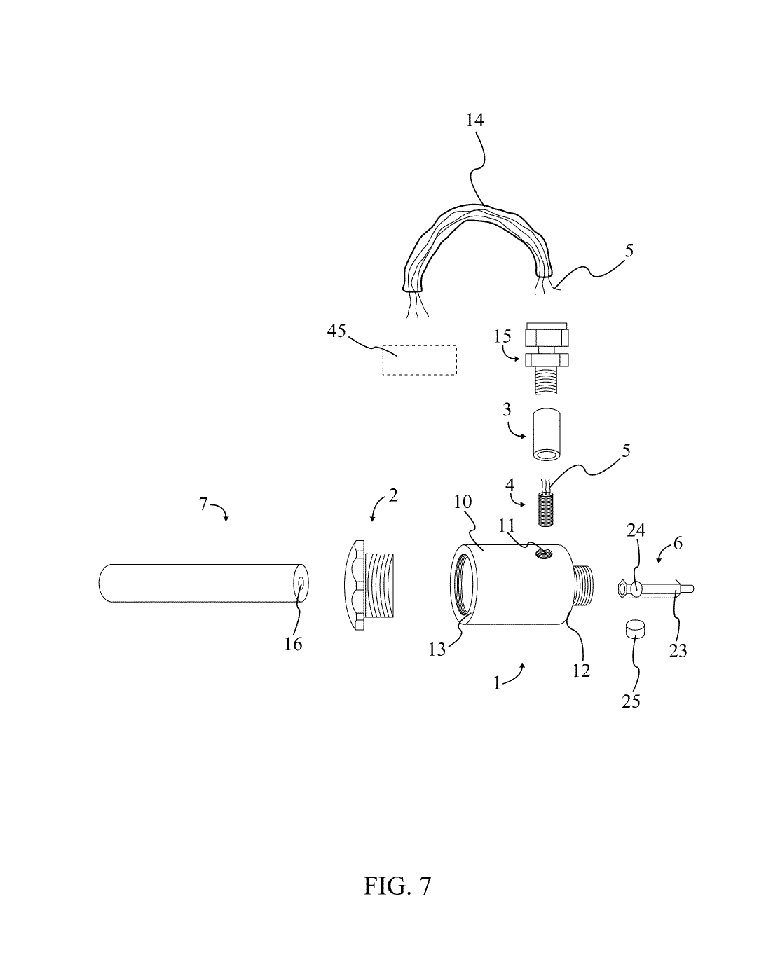

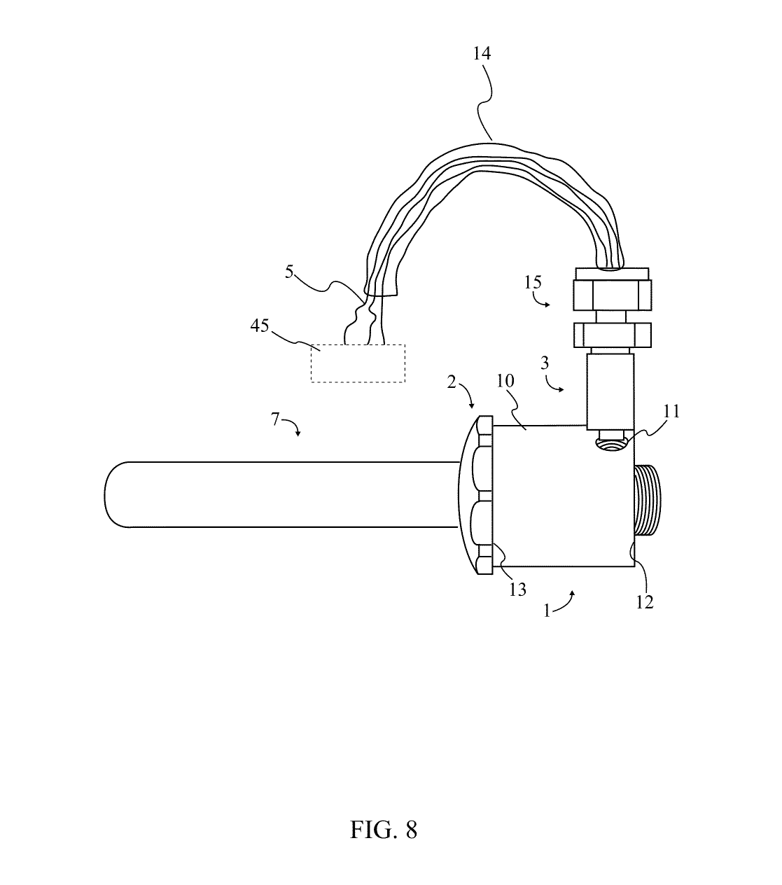

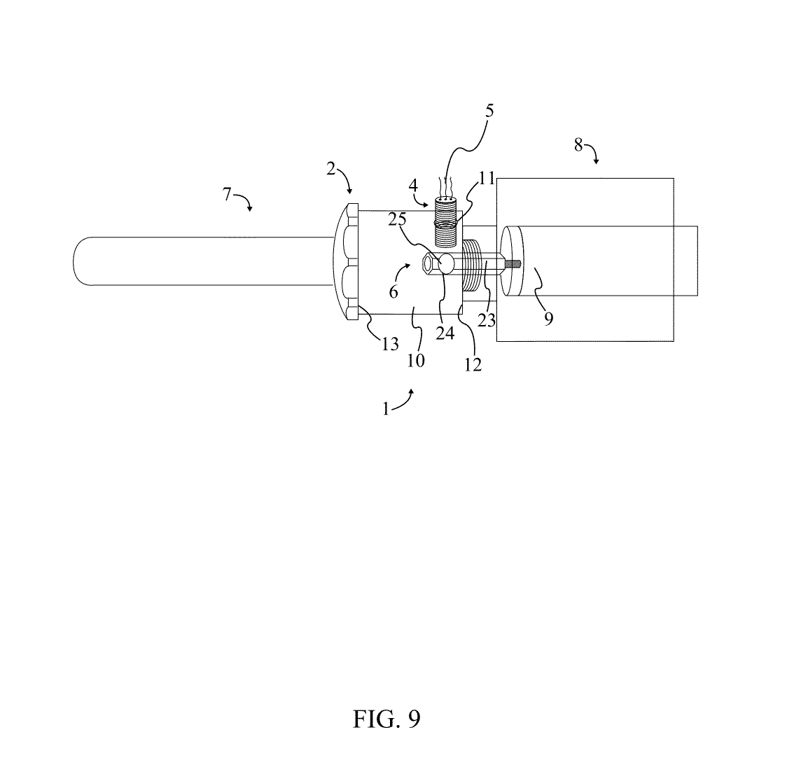

Attached to the free end 13 of the hollow sensor housing 1 is the end cap 2. The end cap 2, originally covering the motor 8, is moved to the free end 13 of the hollow sensor housing 1 when the present invention is retrofitted to an existing fiberglass applying device. In one embodiment, the present invention further comprises a handle 7 (FIG. 6) which is attached to the end cap 2. The handle 7 comprises a first end 16, which is used to attach the handle 7 to the end cap 2. To create a better fit between the first end 16 and the end cap 2, the first end 16 is dimpled to match the contour of the end cap 2, resulting in a flush connection. The handle 7 provides an ergonomic grip that makes the present invention and attached fiberglass applying device easier to hold and operate. This completed embodiment is depicted in FIG. 7, FIG. 8, and FIG. 9.

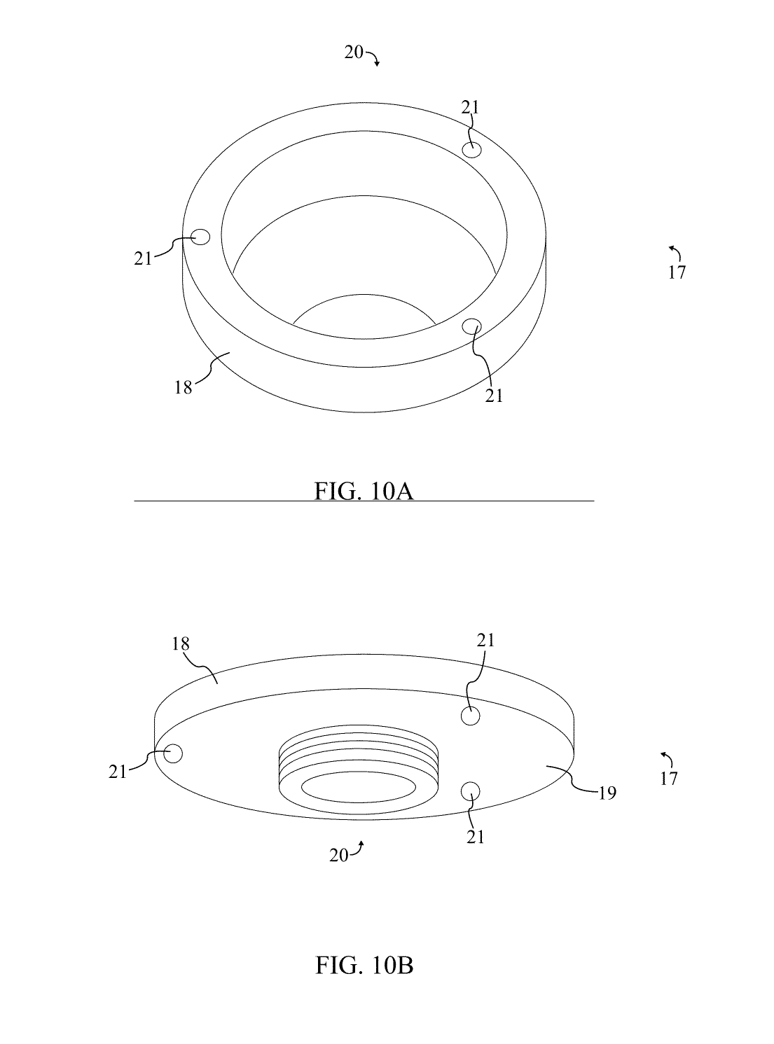

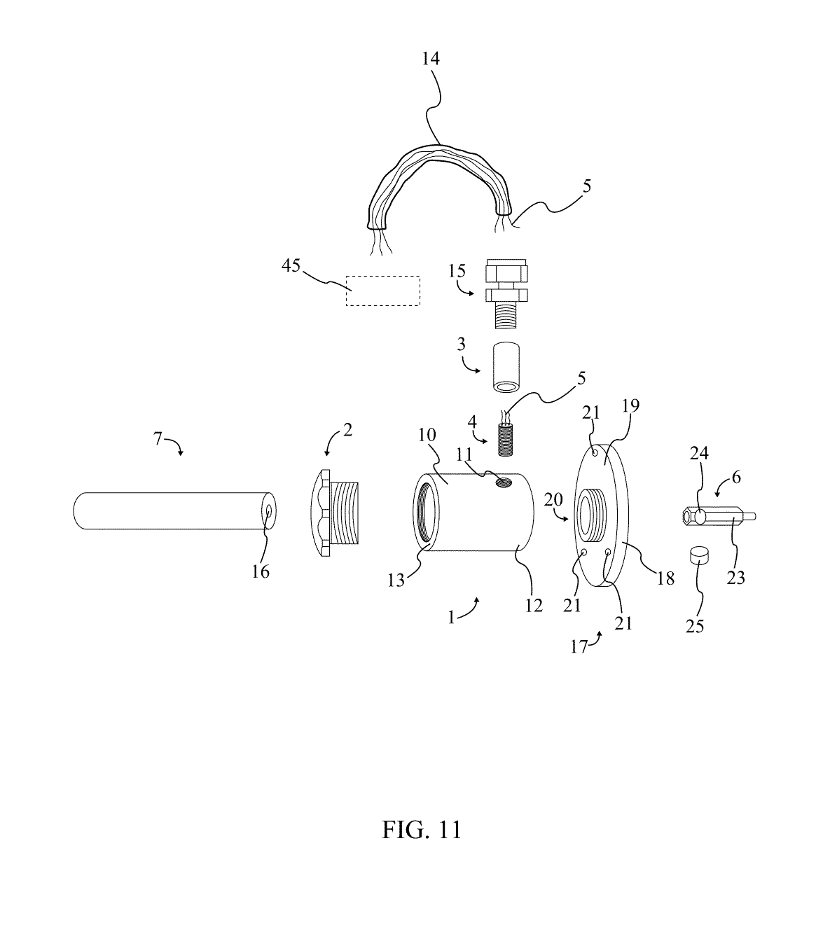

As some fiberglass applying devices do not have a removable end cap 2, and instead are covered with a housing plate, another embodiment of the present invention provides an adapter mounting plate 17. Shown in FIG. 10A, FIG. 10B, and FIG. 11, the adapter mounting plate 17 comprises an annular body 18, a flange 19, a bore 20, and a plurality of mounting holes 21 positioned in a circle on the flange 19. The default housing plate of the motor 8 is removed and the flange 19, which forms one end of the adapter mounting plate 17, is pressed against the motor 8. The bore 20 forms an inner hole in the adapter mounting plate 17, providing an opening which allows the standoff 6 to extend from the motor 8 into the hollow sensor housing 1. The plurality of mounting holes 21 traverse into the flange 19 and are aligned with a corresponding plurality of fastener holes 22 on the motor 8. The plurality of fasteners 23 that had previously secured the housing plate to the motor 8 can now be inserted through the plurality of mounting holes 21 into the plurality of fastener holes 22, securing the adapter mounting plate 17 to the motor 8. The end of the annular body 18 opposite the flange 19 is then used as an attachment point for the motor end 12 of the hollow housing sensor. In the preferred embodiment, the attachment between the motor end 12 and the adapter mounting plate 17 utilizes matching threads to allow the hollow sensor housing 1 to screw into the adapter mounting plate 17.

The standoff 6 comprises an elongated body 23, a cavity 24, and a magnet 25. The elongated body 23 is attached to the armature 9 of the motor 8, such that the standoff 6 rotates with the armature 9. The cavity 24 is positioned adjacent on a sensor end of the elongated body 23, opposite the armature 9. The cavity 24 receives the magnet 25, such that rotation of armature 9 and elongated body 23 causes the magnet 25 to follow a circular path about the axis of rotation.

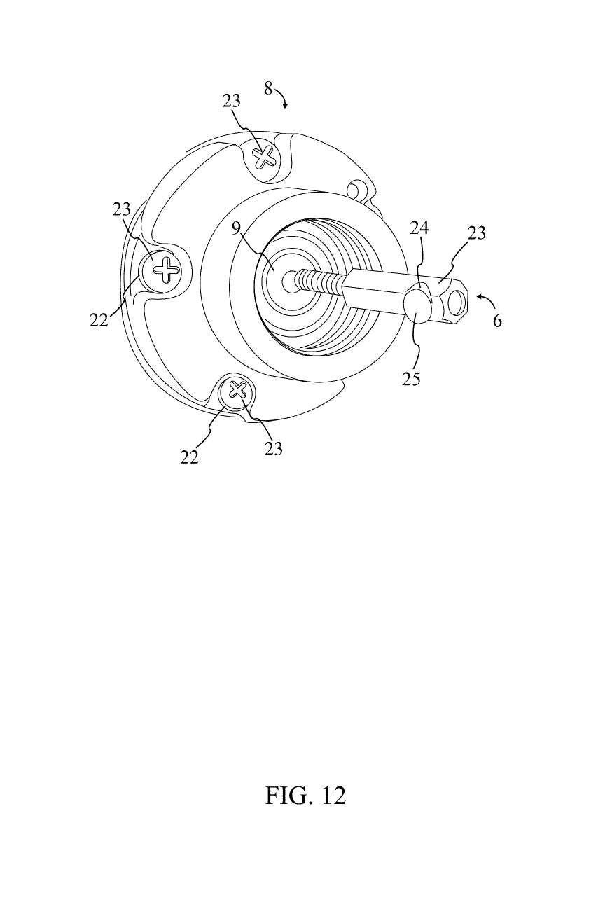

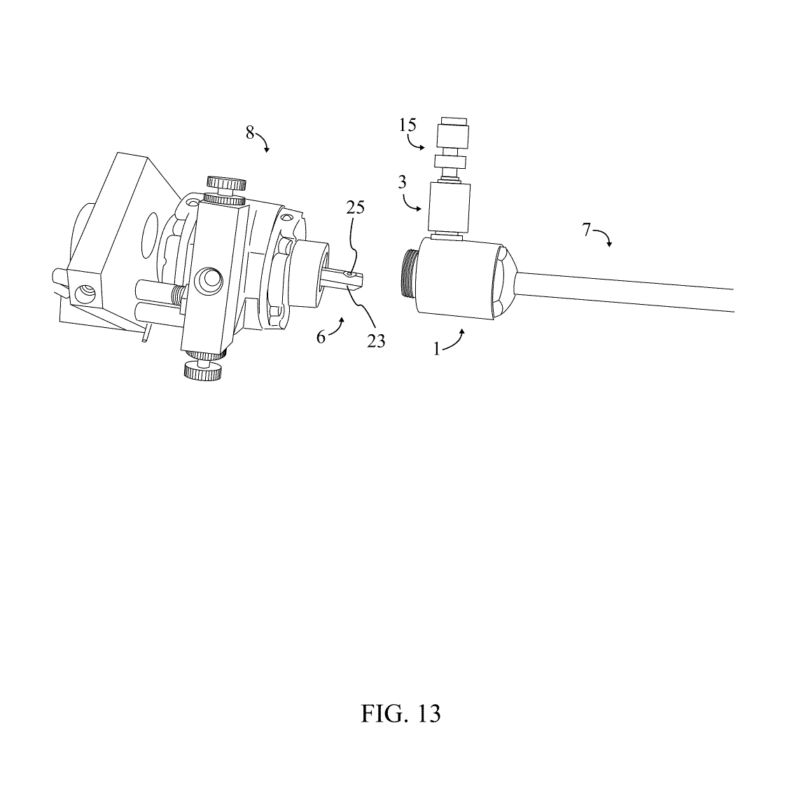

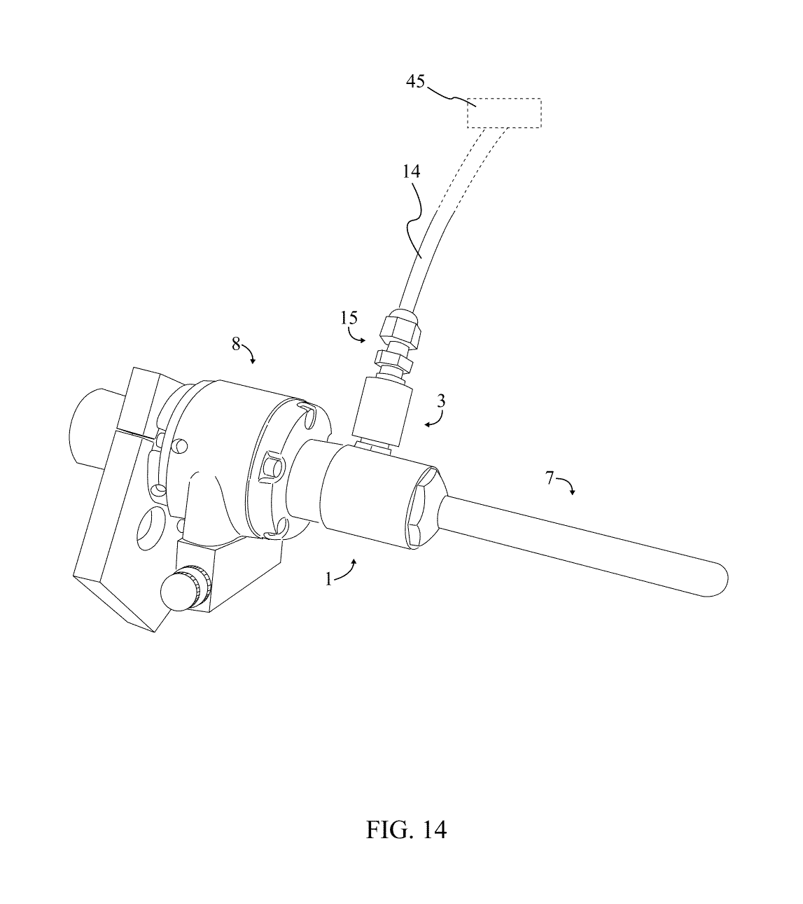

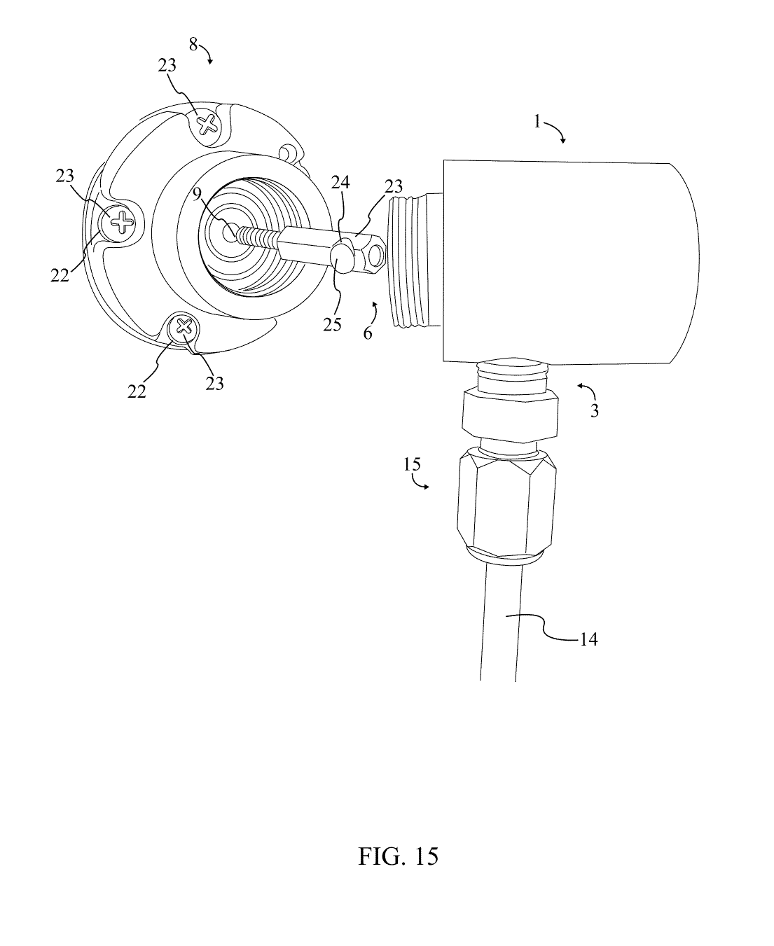

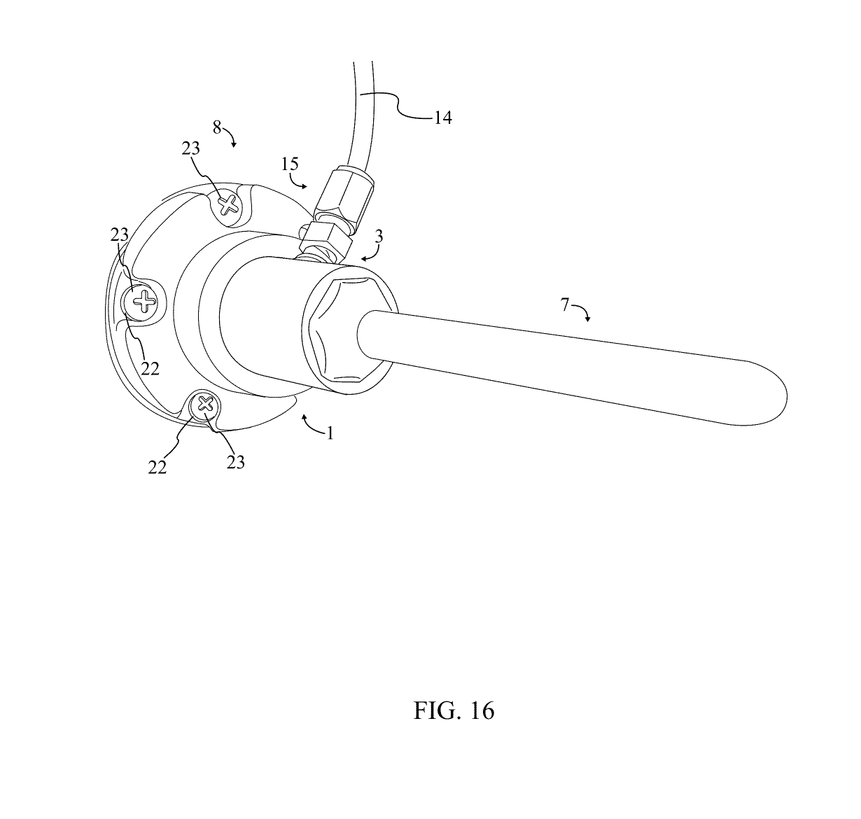

The attachment of the hollow sensor housing 1 to the motor 8 results in the standoff 6 traversing into the hollow sensor housing 1 through the motor end 12. The cavity 24 and its associated magnet 25 are resultantly positioned with the hollow sensor housing 1 adjacent to the hall effect sensor 4. They are positioned so that the angular movement of the magnet 25 is situated on a plane aligned with the hall effect sensor 4. This arrangement is integral to the function of the present invention as the hall effect sensor 4 detects each revolution of the standoff 6 (and attached armature 9) through motion of the magnet 25. The final configuration is visualized in FIG. 15 and FIG. 16, with the assembly process being illustrated in FIG. 12, FIG. 13, and FIG. 14.

In the preferred embodiment of the present invention threaded engagements are used as the primary means of attaching components. For example, matching threading is provided on the adapter hole 11 and the sensor adapter 3 which allows one end of the sensor adapter 3 to screw into the adapter hole 11. Likewise, matching threads on the motor 8 and motor end 12, as well as free end 13 and end cap 2, allow the respective components to be helically engaged with each other.

After installation the present invention can be used to indirectly determine the weight of strand fiberglass. Since the motor 8 and armature 9 are used to power a feed unit 47 and dispenser 48, each rotation of the armature 9 causes a rotation of the feed unit 47. Since each rotation of the feed unit 47 moves a set length of strand fiberglass through the motor 8, the length of strand fiberglass being dispensed can be monitored. Using linear density, the length of dispensed strand fiberglass can then be converted into a weight.

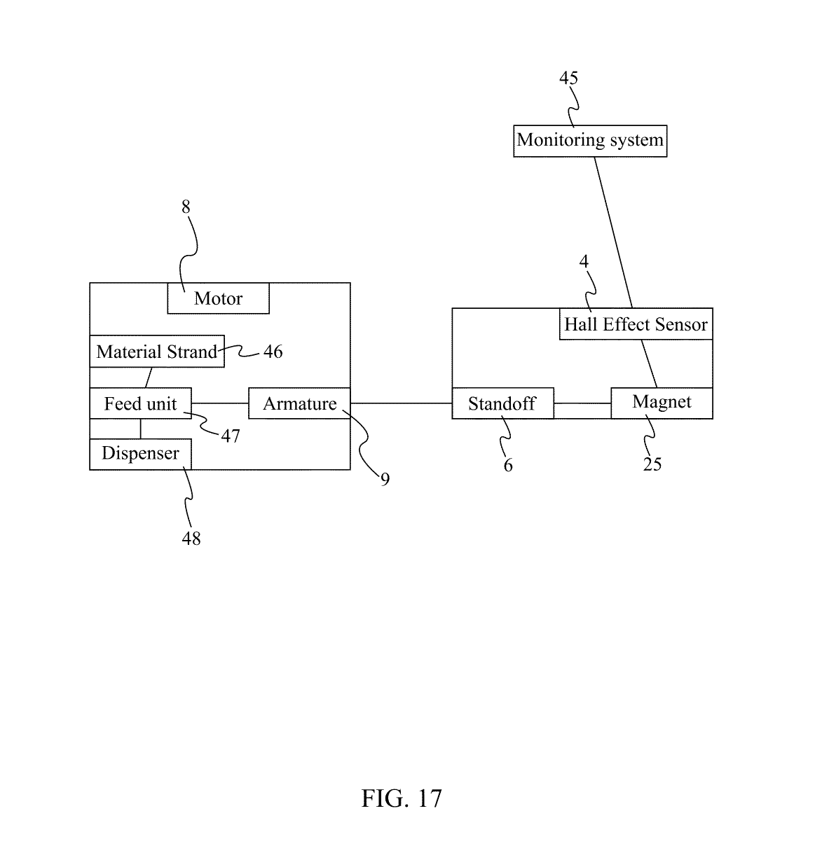

The process of utilizing the present invention to measure the weight of strand material 46 requires a chopper motor with a feed unit, a dispenser 48, a motor 8, and an armature 9, as well as a supply of strand material 46. In the preferred embodiment the strand material 46 is strand fiberglass. The standoff 6, magnet 25, and hall effect sensor 4 of the present invention are used to detect rotation of the armature 9 and transmit the data to a electrically connected monitoring system 45. An outline of the components used for operation of the present invention and their interaction is shown in FIG. 17.

The standoff 6 is attached to the armature 9 such that each rotation of the armature 9 causes a rotation of the standoff 6, resulting in the connected magnet 25 following a circular path. The hall effect sensor 4 is positioned to detect the magnet 25, by receiving a magnetic pulse, each time it passes by the hall effect sensor 4; thus, every detection of the magnet 25 indicates a rotation of the standoff 6 corresponding to a single rotation of the armature 9. Using this detection capability, the present invention records a current rotation account, which is used to determine the length and eventually weight of the strand material 46 which has been moved by the feed unit 47 to the dispenser 48.

The current rotation count, which is used to determine the length of material dispensed, is set to zero for each use of the present invention. During operation of the present invention and attached chopper motor, each detected single rotation of the armature 9 (indicated by a corresponding rotation of the standoff 6) increases the current rotation count by one. Providing a rotation radius of the feed unit and a linear density of the strand material 46, the current rotation count can be used to calculate a weight of the dispensed strand material 46. Multiplying the current rotation count by the rotation radius provides a linear length of material that has passed from the feed unit to the dispenser 48. Once the length of material has be obtained, the weight of material is solved for by multiplying the length of material by the associated linear density of the strand material 46.

The calculated weight of material is output through the monitoring system 45, allowing a user to easily see how much weight of material has been passed through the chopper motor and applied to a surface. This allows for real time, continuous, and indirect weighing of applied strand material 46.

Although the invention has been explained in relation to its preferred embodiment, it is to be understood that many other possible modifications and variations can be made without departing from the spirit and scope of the invention as hereinafter claimed.

What is claimed is:

1. An indirect material weighing sensor comprises:
a hollow sensor housing;
an end cap;
a sensor adapter;
a hall effect sensor;
a sensor wire;
a standoff;
the sensor housing comprises an annular wall, an adapter hole, a motor end, and a free end;
the standoff comprises an elongated body, a cavity, and a magnet;
the sensor adapter traversing into the adapter hole;
the hall effect sensor traversing from sensor adapter into the hollow sensor housing;
the sensor wire being electrically connected to the hall effect sensor;
the standoff traversing into the hollow sensor housing through the motor end; and
the end cap being attached to the free end.

2. The indirect material weighing sensor as claimed in claim 1 comprises:
the standoff being axially attached to an armature of a motor;
the cavity being positioned opposite the armature along the elongated body; and
the magnet being positioned within the cavity.

3. The indirect material weighing sensor as claimed in claim 2 comprises:
the motor being operatively coupled to a feed unit; and
a feed unit being operatively coupled to a dispenser, wherein the feed unit pushes a strand material through the dispenser.

4. The indirect material weighing sensor as claimed in claim 2 comprises;
the motor end being positioned adjacent to the motor; and
the hollow sensor housing being attached to the motor, wherein the motor end screws into the motor.

5. The indirect material weighing sensor as claimed in claim 2 comprises:
an adapter mounting plate;
the adapter mounting plate comprises an annular body, a flange, a bore, and a plurality of mounting holes;
the bore axially traversing through the annular body;
the plurality of mounting holes being radially positioned along the flange;
the plurality of mounting holes traversing normally through the flange;
the flange being adjacently attached to the motor, wherein the plurality of mounting holes align with a plurality of fastener holes on the motor; and
a plurality of fasteners traversing through the plurality of mounting holes into the plurality of fastener holes.

6. The indirect material weighing sensor as claimed in claim 1 comprises:
the adapter hole laterally traversing through the annular wall;
the hall effect sensor traversing into the hollow sensor housing through the adapter hole; and
the magnet being positioned adjacent to the hall effect sensor.

7. The indirect material weighing sensor as claimed in claim 1 comprises:
the sensor wire being sleeved by a protective tubing;
the protective tubing being attached to the sensor adapter by a compression fitting, wherein the compression fitting forms a seal around the sensor adapter; and
the hall effect sensor being electrically connected to a monitoring system by the sensor wire.

8. The indirect material weighing sensor as claimed in claim 1 comprises:
a handle;
the handle comprises a first end;
the first end being positioned adjacent to the end cap opposite the hollow sensor housing;
the handle being attached to the end cap; and
the first end being dimpled, wherein the end cap is flush with the first end.

9. A method for measuring the weight of strand material dispensed from a chopper comprises the steps of:
providing a chopper comprising a feed unit, a dispenser, a motor, and an armature;
providing an indirect material weighing sensor;
wherein a magnet is connected to a standoff of the indirect material weighing sensor;
wherein the standoff which is connected to the armature and a hall effect sensor is placed adjacent to the standoff;
providing a monitoring system, wherein the material strand measurement system is communicably coupled to the monitoring system;
receiving a strand material through the feed unit;
rotating the motor to move the strand material from the feed unit to the dispenser;
recording a single rotation of the armature by using the hall effect sensor to record a corresponding rotation of the standoff;
calculating a current length of material passed through the dispenser by multiplying a current rotation count by a rotation radius, wherein the rotation radius is a radius of the feed unit;
converting the length of material into a weight of material by multiplying the length of material by a linear density of the strand material; and
outputting the weight of material through the monitoring system.

10. The method for measuring the weight of strand material dispensed from a chopper as claimed in claim 9 further comprises the steps of:
assigning the current rotation count a value of zero;
recording a single rotation from the plurality of rotations by detecting the magnet through the hall effect sensor; and
increasing the value of the current rotation count by one for each recorded single rotation.

11. An indirect material weighing sensor comprises:
a hollow sensor housing;
an end cap;
a sensor adapter;
a hall effect sensor;
a sensor wire;
a standoff;
the sensor housing comprises an annular wall, an adapter hole, a motor end, and a free end;
the standoff comprises an elongated body, a cavity, and a magnet;
the sensor adapter traversing into the adapter hole;
the hall effect sensor traversing from sensor adapter into the hollow sensor housing;
the sensor wire being electrically connected to the hall effect sensor;
the standoff traversing into the hollow sensor housing through the motor end;
the end cap being attached to the free end;
the standoff being axially attached to an armature of a motor;
the cavity being positioned opposite the armature along the elongated body;
the magnet being positioned within the cavity;
the adapter hole laterally traversing through the annular wall;
the hall effect sensor traversing into the hollow sensor housing through the adapter hole; and
the magnet being positioned adjacent to the hall effect sensor.

12. The indirect material weighing sensor as claimed in claim 11 comprises:
the motor being operatively coupled to a feed unit; and
a feed unit being operatively coupled to a dispenser, wherein the feed unit pushes a strand material through the dispenser.

13. The indirect material weighing sensor as claimed in claim 11 comprises;
the motor end being positioned adjacent to the motor; and
the hollow sensor housing being attached to the motor, wherein the motor end screws into the motor.

14. The indirect material weighing sensor as claimed in claim 11 comprises:
an adapter mounting plate;
the adapter mounting plate comprises an annular body, a flange, a bore, and a plurality of mounting holes;
the bore axially traversing through the annular body;
the plurality of mounting holes being radially positioned along the flange;
the plurality of mounting holes traversing normally through the flange;
the flange being adjacently attached to the motor, wherein the plurality of mounting holes align with a plurality of fastener holes on the motor; and
a plurality of fasteners traversing through the plurality of mounting holes into the plurality of fastener holes.

15. The indirect material weighing sensor as claimed in claim 11 comprises:
the sensor wire being sleeved by a protective tubing;
the protective tubing being attached to the sensor adapter by a compression fitting, wherein the compression fitting forms a seal around the sensor adapter; and
the hall effect sensor being electrically connected to a monitoring system by the sensor wire.

16. The indirect material weighing sensor as claimed in claim 11 comprises:
a handle;
the handle comprises a first end;
the first end being positioned adjacent to the end cap opposite the hollow sensor housing;
the handle being attached to the end cap; and
the first end being dimpled, wherein the end cap is flush with the first end.
